(19) United States
(12) Patent Application Publication
(10) Pub. No.: US 2010/0064442 A1
(43) Pub. Date: Mar. 18, 2010

(54) PATIENT LOAD SUPPORT FOR USE WITH ELONGATE BEDS

(75) Inventors: George E. Riehm, New Fairfield, CT (US); Douglas B. Winner, Newtown, CT (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: JOERNS HEALTHCARE, INC., Stevens Point, WI (US)

(21) Appl. No.: 12/405,005

(22) Filed: Mar. 16, 2009

Related U.S. Application Data
(60) Provisional application No. 61/069,493, filed on Mar. 14, 2008.

(51) Int. Cl. A47C 31/00; A61G 7/10

(52) U.S. Cl. 5/662

(57) ABSTRACT

A patient load support for use with elongate beds comprises a frame, and a grip supported relative to the frame. The grip is supported for longitudinal movement, and independent lateral movement.

### CROSS-REFERENCE TO RELATED APPLICATIONS

This application claims the benefit of U.S. Provisional Application No. 61/069,493, filed Mar. 14, 2008, the disclosure of which is incorporated herein by reference.

### BACKGROUND OF THE INVENTION

This invention relates in general to beds and more particularly to attachments or accessories for use with beds. Most particularly, the invention relates to self-helps, supports or handgrips for use with beds.

It is well known to provide devices for the purpose of aiding patients in repositioning themselves on a bed surface. Such devices are nonessential and are adapted for use with devices other than beds.

### SUMMARY OF THE INVENTION

This invention relates to a patient load support for use with elongate beds. The patient load support comprises a frame, and a grip supported relative to the frame. The grip is supported for longitudinal movement, and independent lateral movement.

This invention further relates to a patient load support for an elongated bed. The patient load support comprises a frame supported at the head end of the bed. The frame includes two uprights, two parallel, horizontal booms, and a transverse support. The transverse support spans the booms, and is moveable longitudinally along them. A grip supported from the transverse support is moveable laterally.

This invention further relates to a patient load support comprising a frame supported relative to a bed. The frame includes a substantially vertical upright and a first and second substantially horizontal booms. A transverse support spans the two booms and is moveable relative to the booms. A first and second locking assembly fix the transverse relative to the first and second booms. A carriage is moveably supported on the transverse support. A carriage lock is configured to prevent movement of the carriage relative to the transverse support. A grip is supported by the carriage.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a front perspective view of a patient load support.

FIG. 2 is a perspective view, taken from above, of a boom lock from the patient load support shown in FIG. 1. The lever plate on the top of the boom lock has been shown transparently so that underlying components are visible.

FIG. 3 is a perspective view taken from below of a carriage from the patient load support shown in FIG. 1.

FIG. 4 is a cross-sectional view of the carriage from FIG. 3.

FIG. 5 is a rear perspective view of the patient load support mounted on a elongated bed.

### DETAILED DESCRIPTION OF THE PREFERRED EMBODIMENT

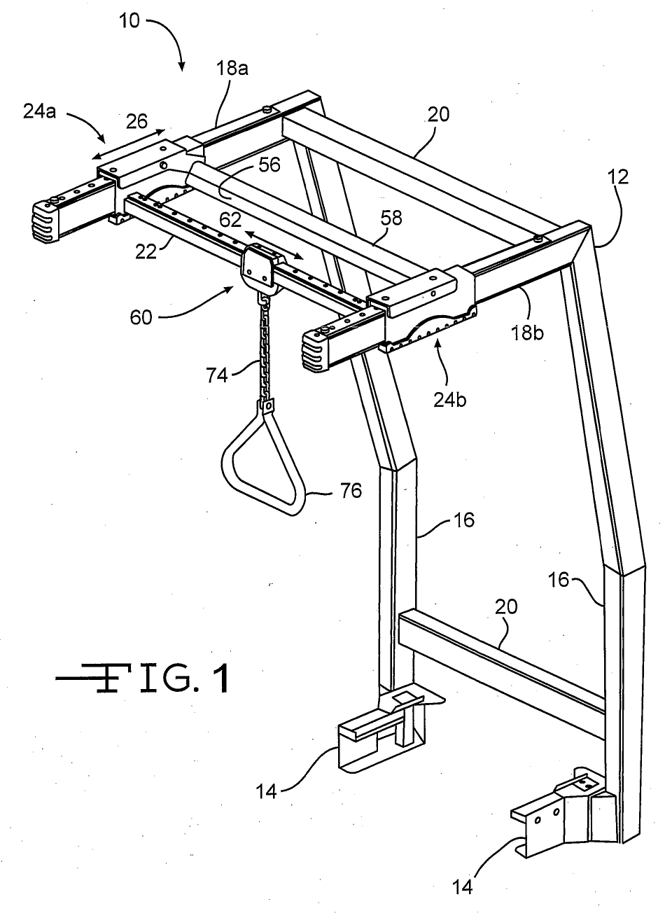

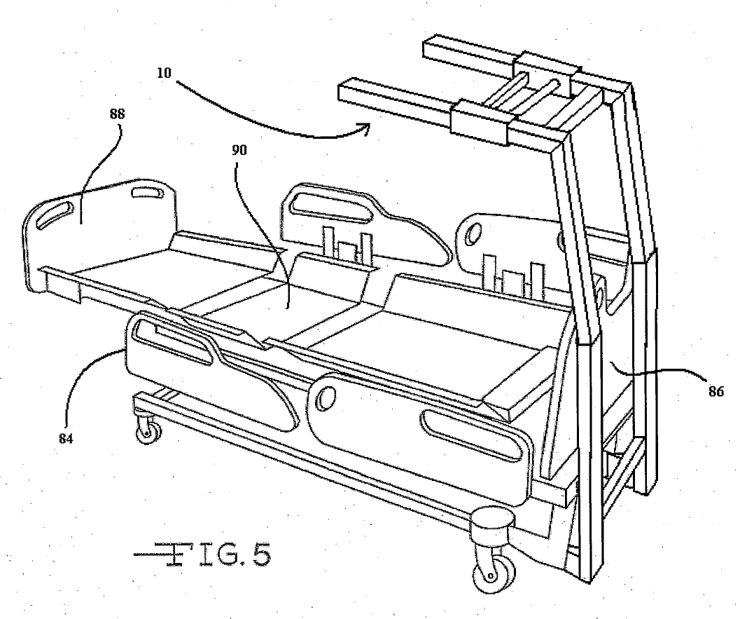

Referring now to the drawings, there is illustrated in FIG. 1 a patient load support, generally indicated at 10. As shown in FIG. 5, the patient load support 10 is adapted for use with an elongated bed 84 having a head end 86, a foot end 88, and a mattress-supporting central section or bed frame 90. It should be appreciated that the patient load support 10 is suitable with devices other than an elongated bed. Referring back to FIG. 1, it can be seen that the patient load support 10 comprises a support structure, such a frame 12, which may be in the form of a weldment or an assembly of parts, which may be welded or otherwise joined together. The frame 12 may be coupled to the bed or other device with suitable couplings 14, such as the couplings shown, which are suitable for coupling the frame 12 to the bed frame (not shown). The patient load support 10 is configured to attach to a bed frame at a head end, but it should be appreciated that the patient load support 10 can be attached to other ends of a bed, or can be supported relative to some device other than a bed.

The frame 12 includes two substantially vertical uprights 16. As shown, the uprights 16 include a vertical portion and an angled portion. This is not necessary, and the design of the uprights can be different from that shown. The uprights support two cantilevered, substantially horizontal booms 18a and 18b. The booms 18a and 18b are substantially parallel to each other. Crossbeams 20 connect the two uprights 16 and help provide stability to the patient load support 10. The components of the frame 12 can be made of any suitable material, such as aluminum or steel. The components of the frame 12 can be connected by any suitable means, including welding, riveting or bolting. Although a particular structure for the frame 12 has been shown, it should be appreciated that the patient load support 10 may have a different configuration than that illustrated.

The patient load support 10 includes a transverse support 22. The transverse support 22 is attached to a first boom lock assembly, indicated generally at 24a moveably supported on the first boom 18a, and a second boom lock assembly, indicated generally at 24b moveably supported on the second boom 18b. The boom locks assemblies 24a and 24b are configured to be slid along the respective booms 18a and 18b, in the direction indicated by the arrow 26. The movement in the direction 26 is longitudinal with respect to the elongate bed that the patient load support 10 is mounted relative to. In order to facilitate movement, the boom locks 24a and 24b may include carriages or trolleys, and may include wheels or rollers, nylon or Teflon bearing surfaces, or other suitable low-friction structure.

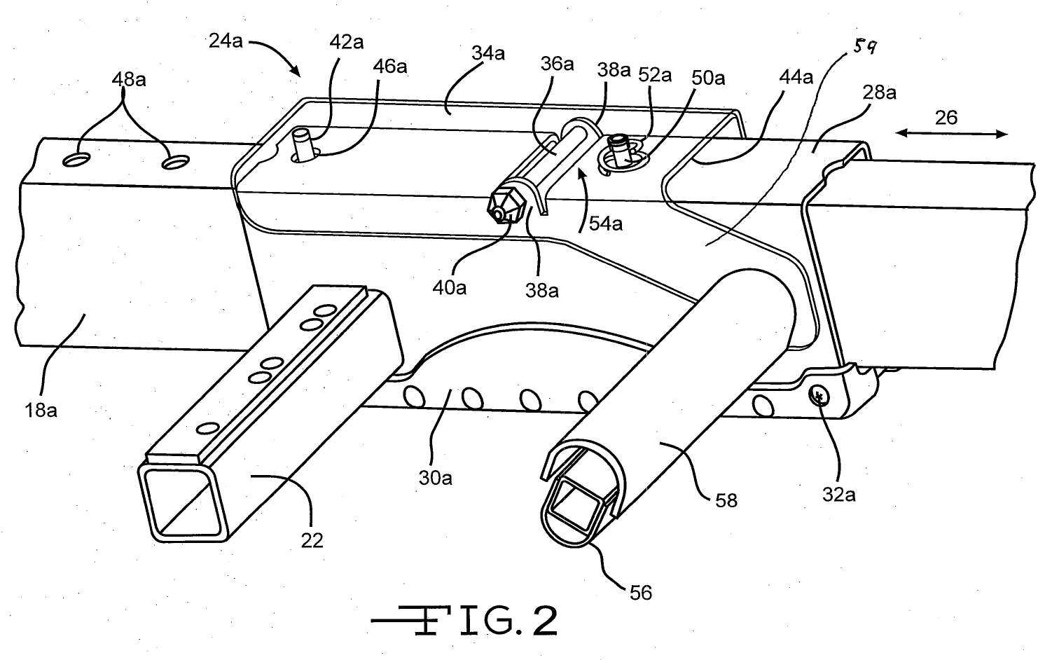

In reference to FIG. 2, the first boom lock assembly 24a will be described in greater detail. The first boom lock assembly 24a includes an upper body 28a and a lower body 30a. The upper body 28a and lower body 30a surround the first boom 18a and are attached to each other by screws 32a or by other suitable means. The first boom lock assembly 24a also includes a lever plate 34a. Lever plate 34a is shown transparently in FIG. 2 so that underlying components are visible. . Lever plate 34a is pivotally attached to the upper body 28a. A pivot pin 36a passes through brackets 38a on the upper body. The pivot pin 36a extends through the lever plate 34a and is retained in place by cap nut 40a or some other suitable attachment. The lever plate 34a is able to rotate relative to the upper body 28a about the axis of the pivot pin 36a.

Lever plate 34a includes a locking pin 42a. The locking pin 42a is attached to the lower surface 44a of the lever plate 34a and projects downward. The locking pin 42a is positioned to pass through an upper hole 46a in the upper body 28a. The upper hole 46a is configured to allow the locking pin 42a to move freely when the lever plate 34a is rotated. A series of first indexing holes 48a is included on the first boom 18a. The locking pin 42a and the first indexing holes 48a are configured so that the locking pin 42a is able to pass through the upper hole 46a, and project into one of the first indexing holes 48a. When the locking pin 42a is projecting into one of the first indexing holes 48a, the locking pin 42a helps prevent longitudinal movement of the boom lock 24a in the direction of arrow 26.

A guide 50a and a compression loaded spring 52a are located between the upper body 28a and the lever plate 34a. The spring 52a is provided to bias the lever plate 34a in a first direction, counterclockwise as viewed in FIG. 2, as indicated by arrow 54a. By biasing the lever plate 34a in the first direction 54a, the locking pin 42a is biased to engage one of the first indexing holes 48a. When an operator wishes to move the first boom lock 18a in the longitudinal direction, the operator applies a force to the lever plate 34a opposite the first direction 54a. When the operator overcomes the force of the spring 52a, the lever plate 34a will rotate clockwise as viewed in FIG. 2. The locking pin 42a will be withdrawn from the first indexing holes 48a and the operator is able to slide the first boom lock 24a longitudinally along the first boom 18a. When the operator releases the force on the lever plate 34a, the spring 52a will cause the lever plate 34a to rotate counterclockwise as viewed in FIG. 2. The locking pin 42a will then engage one of the first indexing holes 48a. The locking pin 42a may not immediately engage one of the first indexing holes 48a, since the first boom lock 24a may not be properly aligned with one of the first indexing holes 48a. However, the operator simply needs to move the first boom lock 24a either forward or aft until the locking pin 42a does align with one of the first indexing holes and the locking pin 42a will engage the first indexing hole 48a, preventing further movement of the first boom lock 24a. Although a compression loaded spring has been shown, it should be appreciated that other mechanism for biasing the lever plate 34a can be used.

The first boom lock 24a is a longitudinal locking assembly that helps prevent longitudinal movement of the transverse support 22. The first boom lock 24a is configured to fix the position of the transverse support 22 at specific points, as determined by the positioning of the first indexing holes 48a. It should then be appreciated that the available locking positions of the first boom lock 24a can by varied by the positions of the first indexing holes 48a. It should also be appreciated that while one particular type of locking mechanism has been described in detail, other suitable mechanism can be used to prevent longitudinal movement.

The first boom lock 24a may be adjusted in relation to the first boom 18a and locked, firmly fastened, secured, or otherwise held in place in relation to the first boom 18a. This may be accomplished in any suitable manner. For example, the first boom lock 24a may be comprised of channel members sized and configured to receive the first boom 18a. The first boom 18a may be provided with some other interlocking structure, such as a plurality of detents, recesses, holes, or other suitable demarcations. The interlocking structure may be discretely spaced by separate and distinct units of spacing. Indicia (not shown) may be associated with each unit of spacing to aid a user in adjusting the longitudinally movable first boom lock 24a to a desired position.

Three transverse or laterally oriented components are connected to the first boom lock 24a. The transverse support 22 is attached to the upper body 28a. A fixed transverse handle 56 is also attached to the upper body 28a. These components can be attached by any suitable means, including bolting or welding. It should be appreciated that either of these two components could be attached to the lower body 30a. The transverse support 22, fixed transverse handle 56, first boom lock 24a and second boom lock 24b form a four bar system. However, it should be appreciated that this particular configuration is not necessary. A pivot transverse handle 58 is attached to a flange or tongue 59 of the lever plate 34a. The fixed transverse handle 56 and the pivot transverse handle 58 are sized to be graspable by the operator. These components are also provided with rounded cross sectional shapes in order to make them comfortable for the operator to grip. As can be appreciated in reference to FIG. 1, the transverse support 22, the fixed transverse handle 56 and the pivot transverse handle 58 are also attached to the second boom lock 24b. The second boom lock 24b is configured as the mirror image of the first boom lock 24a, and will not be separately described. The transverse components connecting the first boom lock 24a and the second boom lock 24b cause these two components to move longitudinally in unison.

The pivot transverse handle 58 helps the operator to rotate the first lever plate 34a and the second lever plate 34b simultaneously. Rotation of the first lever plate 34a causes the pivot transverse handle 56 to move downward as viewed in FIG. 2. This causes a complementary rotation of the second lever plate 34b. Therefore, the operator is able to unlock the first boom lock 24a and the second boom lock 24b at the same time. It should be appreciated that this configuration allows the operator to release both the first boom lock 24a and the second boom lock 24b by applying force to any of the first lever plate 34a, the second lever plate 34b and the pivot transverse handle 58. This arrangement allows the operator to unlock the first boom lock 24a and the second boom lock 24b from either side of the bed.

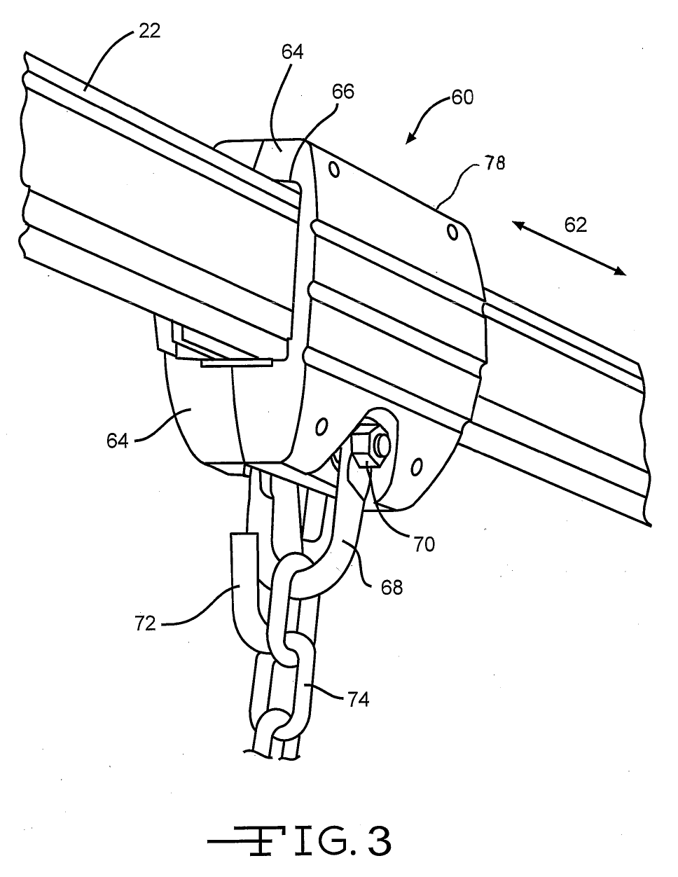

As can be seen in FIG. 1, the transverse support 22 supports a carriage, indicated generally at 60. The carriage 60 is shown in greater detail in FIG. 3. The carriage 60 is configured for movement relative to the transverse support 22 in the direction indicated by arrow 62. The movement in the direction 62 is lateral with respect to the elongate bed that the patient load support 10 is mounted relative to. In order to facilitate movement, the carriage 60 may include, for example, wheels or rollers, nylon or Teflon bearing surfaces, or other suitable low-friction structure.

The carriage 60 is comprised of two C-shaped brackets 64 that are held together by screws (not shown) or any other suitable means. The two brackets 64 define an aperture 66 that accommodates the transverse support 22. The carriage 60 supports a U-bolt 68 that is attached by a bolt and nut 70. The carriage 60 also supports an S-hook 72. A tether 74 is supported by the u-bolt 68. As seen in reference to FIG. 1, an appendage or attachment 76, such as a trapeze, grip, handhold, handle or other suitable structure, may be supported in relation to the tether 74. The attachment 76 may provide a hold or grip point accessible by a patient positioned in the bed. The distance between the carriage 60 and the attachment 76 can be controlled by, for example, attaching the tether 74 to the s-hook 72. The illustrated tether 74 is a chain, but any suitable tether may be used, such as a strap, rope, cord or the like.

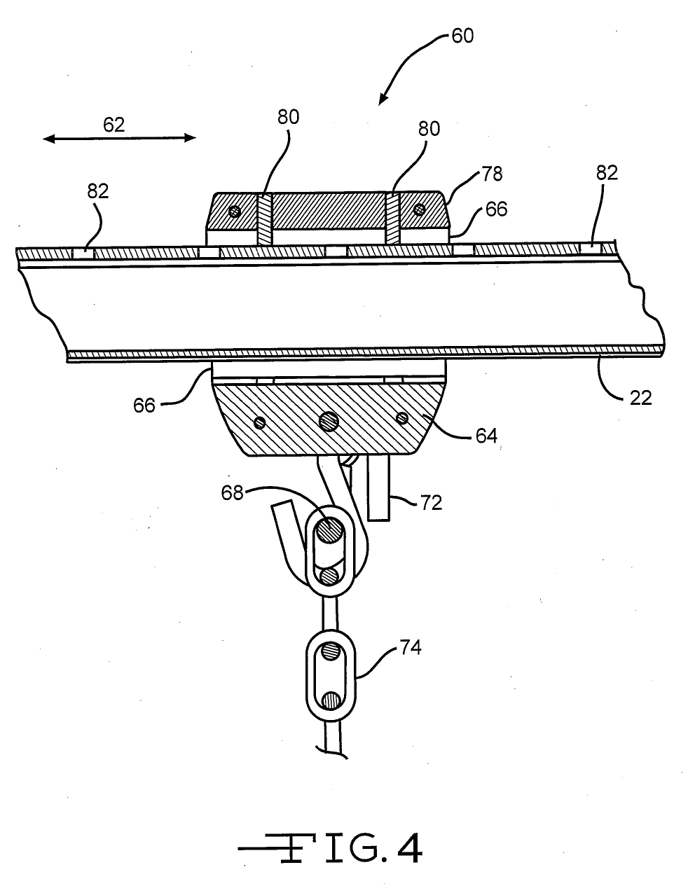

The carriage 60 is shown in cross section in FIG. 4. The carriage 60 is configured so that the operator may raise the carriage 60 relative to transverse support 22. This is accomplished by making the aperture 66 taller than the transverse support 22. An upper arm 78 of the carriage 60 supports two carriage pins 80 that project into the aperture 66. The transverse support 22 includes a series of transverse indexing holes 82. The carriage pins 80 are configured to engage with the transverse indexing holes 82. It should be appreciated that FIG. 4 shows the carriage 60 in the raised position, with the carriage pins 80 resting on top of the transverse support 22. The carriage 60, as shown in FIG. 4, is free to move laterally until the carriage pins 80 align with the transverse indexing holes 82. At that point, gravity will cause the carriage 60 to move down and the carriage pins 80 will engage the transverse indexing holes 82. The carriage 60 is then locked against further lateral movement 62 until the operator raises the carriage relative to the transverse support 22.

The carriage pins 80 and transverse indexing holes 82 cooperate to provide a latitudinal lock assembly that helps prevent lateral movement of the carriage 60. The latitudinal lock assembly is configured to fix the position of the carriage 60 at specific points, as determined by the positioning of the transverse indexing holes 82. It should then be appreciated that the available locking positions of the carriage 60 can by varied by the positions of the transverse indexing holes 82. It should also be appreciated that while one particular type of locking mechanism has been described in detail, other suitable mechanisms can be used to prevent lateral movement.

The carriage 60 may be adjusted in relation to the transverse support 22 and locked, firmly fastened, secured, or otherwise held in place in relation to the first transverse support 22. This may be accomplished in any suitable manner. For example, the carriage 60 may be comprised of channel members sized and configured to receive the transverse support 22. The transverse support 22 may be provided with some other interlocking structure, such as a plurality of detents, recesses, holes, or other suitable demarcations. The interlocking structure may be discretely spaced by separate and distinct units of spacing. Indicia (not shown) may be associated with each unit of spacing to aid a user in adjusting the laterally movable carriage 60 to a desired position.

It should be appreciated that the patient load support 10 provides an attachment 76 that may be adjusted to a variety of positions over a bed. The patient load support 10 provides the operator with the ability to change the position of the attachment 76 longitudinally, laterally and vertically with respect to the bed. It should also be appreciated that the patient load support 10 allows the adjustment in any one of these directions independent of the other two. That is, the attachment 76 can be locked against lateral movement, while being adjusted longitudinally.

It should be appreciated that the patient load support may have two axes of adjustment along any two axes and that the adjustment may be made in any suitable manner. It should further be appreciated that the movable parts may be power driven, for example, by an electric motor or other suitable structure (not shown). The motor may be operated by a controller or other suitable device (not shown). Controls for the motor may be accessible by the patient and/or an attendant.

The principle and mode of operation of the patient load support have been explained and illustrated as an exemplary embodiment. However, it must be understood that the patient load support may be practiced otherwise than as specifically explained and illustrated without departing from its spirit or scope.

What is claimed is:

1. A patient load support comprising:
a frame configured to be supported relative to an elongated bed; and
a grip supported relative to the frame;
wherein the grip is supported for longitudinal movement with respect to the bed, the grip is supported for lateral movement with respect to the bed, and the lateral movement is independent of the longitudinal movement.

2. The patient load support of claim 1, wherein the frame comprises a substantially vertical upright located at one end of the bed; a substantially horizontal first boom mounted on the upright; and a second boom mounted on the upright substantially parallel to the first boom.

3. The patient load support of claim 2, further comprising a transverse support moveably attached at a first end to the first boom and at a second end to the second boom; wherein the grip is supported relative to the transverse support.

4. The patient load support of claim 3, further comprising a carriage moveably supported on the transverse support, wherein the grip is supported relative to the carriage.

5. The patient load support of claim 4, further comprising a carriage lock assembly configured to prevent movement of the carriage relative to the transverse support when engaged.

6. The patient load support of claim 5, wherein the carriage lock assembly is configured to be released by raising the carriage relative to the transverse support.

7. The patient load support of claim 5, further comprising a first boom lock assembly, configured to prevent movement of the transverse support relative to the first boom when engaged; and
a second boom lock assembly, configured to prevent movement of the transverse support relative to the second boom when engaged.

8. The patient load support of claim 7, wherein the first boom lock assembly and the second boom lock assembly are connected so that they are released simultaneously.

9. The patient load support of claim 8, wherein the first boom lock assembly comprises a series of holes in the first boom and a pin that is mounted to be moved into and out of engagement with one of the holes.

10. The patient load support of claim 9, wherein the pin is attached to a lever that is supported for rotational movement relative to the first boom and the lever is biased so that the pin will engage one of the holes.

11. The patient load support of claim 1, further comprising a longitudinal lock assembly configured to prevent longitudinal movement of the grip relative to the bed when engaged.

12. The patient load support of claim 1, further comprising a latitudinal lock assembly configured to prevent lateral movement of the grip relative to the bed when engaged.

13. The patient load support of claim 1, further comprising a longitudinal lock assembly configured to prevent longitudinal movement of the grip relative to the bed; and
a latitudinal lock assembly configured to prevent lateral movement of the grip relative to the bed when engaged.

14. A patient load support for an elongated bed having a head end, a foot end, and a mattress-supporting central section, the patient load support comprising:
a frame configured to be supported relative to the head end, the frame comprising opposed first and second uprights, a substantially horizontal first boom mounted on the first upright, a substantially horizontal second boom mounted on the second upright substantially parallel to the first boom, and a transverse support spanning the first and second booms, the transverse support being moveably attached to the first and second booms for movement in the longitudinal direction with respect to the bed; and
a grip supported from the transverse support, the grip being movable with respect to the transverse support in a lateral direction with respect to the bed.

15. The patient load support of claim 14, further comprising a longitudinal lock assembly configured to prevent movement of the grip in the longitudinal direction when engaged.

16. The patient load support of claim 15 in which the lock assembly is configured for being unlocked from either one of the ends of the transverse support.

17. The patient load support of claim 15, wherein the longitudinal lock assembly comprises a first boom lock assembly, configured to prevent movement of the transverse support relative to the first boom when engaged, and a second boom lock assembly, configured to prevent movement of the transverse support relative to the second boom when engaged.

18. The patient load support of claim 14, further comprising a transverse lock assembly configured to prevent movement of the grip in the lateral direction when engaged.

19. A patient load support comprising:
a frame configured to be supported relative to an elongated bed, the frame comprising a substantially vertical upright configured to be located at one end of the bed, a substantially horizontal first boom mounted on the upright, and a second boom mounted on the upright substantially parallel to the first boom;
a transverse support moveably attached at a first end to the first boom and at a second end to the second boom;
a first boom lock assembly, configured to prevent movement of the transverse support relative to the first boom when engaged;
a second boom lock assembly, configured to prevent movement of the transverse support relative to the second boom when engaged;
a carriage moveably supported on the transverse support;
a carriage lock assembly configured to prevent movement of the carriage relative to the transverse support when engaged; and
a grip supported relative to the carriage.

20. The patient load support of claim 19, wherein the grip is supported for longitudinal movement with respect to the bed, the grip is supported for lateral movement with respect to the bed, and the lateral movement is independent of the longitudinal movement.
